(19) United States
(12) Patent Application Publication
(10) Pub. No.: US 2022/0159010 A1
(43) Pub. Date: May 19, 2022

(54) CREATING USER ROLES AND GRANTING ACCESS TO OBJECTS FOR USER MANAGEMENT TO SUPPORT MULTI-TENANCY IN A MULTI-CLUSTERED ENVIRONMENT

(71) Applicant: DIAMANTI, INC., San Jose, CA (US)

(72) Inventors: Sambasiva Rao Bandarupalli, Fremont, CA (US); Kshitij Gunjikar, Fremont, CA (US); Taylor Futral, Livermore, CA (US); Satish Ashok, San Jose, CA (US)

(73) Assignee: DIAMANTI, INC., San Jose, CA (US)

(21) Appl. No.: 17/398,246

(22) Filed: Aug. 10, 2021

Related U.S. Application Data
(60) Provisional application No. 63/195,316, filed on Jun. 1, 2021.
(60) Provisional application No. 63/114,295, filed on Nov. 16, 2020.

(51) Int. Cl. H04L 29/06; G06F 21/31

(52) U.S. Cl. CPC H04L 63/105; G06F 21/31

(57) ABSTRACT

Embodiments of the disclosure provide systems and methods for providing access control in a multi-tenant, multi-cluster environment. Providing access control in such an environment can comprise defining, by a domain cluster, a plurality of user roles, each user role having a defined access permission for objects on tenant clusters of the environment. A request can be received by the domain cluster from a user to access the environment and a determination of a user role for the user can be made by the domain cluster. A token can be provided by the domain cluster in response to the request. The token can comprise a definition of access levels for the determined user role for the user and each tenant cluster can control access to the resource objects on the tenant cluster based on the definition of access levels defined in the token.

### CROSS REFERENCE TO RELATED APPLICATION

The present application claims the benefits of U.S. Provisional Application Ser. No. 63/114,295, filed Nov. 16, 2020, entitled “Method and System for Managing Cloud Resources” and U.S. Provisional Application Ser. No. 63/195,316, filed Jun. 1, 2021, entitled “Creating User Roles and Granting Access to Objects for User Management to Support Multi-Tenancy in a Multi-Clustered Environment,” both of which are incorporated herein by this reference in their entirety.

### FIELD OF THE DISCLOSURE

Embodiments of the present disclosure relate generally to methods and systems for multi-tenant cloud computing and more particularly to providing access control in a multi-tenant, multi-cluster environment.

### BACKGROUND

A computer cluster is a set of computers that work together so that they can be viewed as a single system. Cloud-based computer clusters typically provide Platform-as-a-Service (PaaS), Infrastructure-as-a-Service (IaaS), and storage, and other services to tenants. A tenant is a group of users who share a common access with specific privileges to computing resources as may be available on a cluster or across multiple clusters in a multi-clustered environment. When multiple tenants occupy a clustered or multi-clustered environment, their data can exist on the same virtual and/or physical machines. Hence, there is a need for methods and systems for providing access control in a multi-tenant, multi-cluster environment.

### BRIEF SUMMARY

Embodiments of the disclosure provide systems and methods for providing access control in a multi-tenant, multi-cluster environment. According to one embodiment, a method for providing access control in a multi-tenant, multi-cluster environment can comprise defining, by a domain cluster of the multi-tenant, multi-cluster environment, a plurality of user roles. Each user role of the plurality of user roles can have a defined access permission for one or more resource objects on one or more tenant clusters of the multi-tenant, multi-cluster environment. A request can be received by the domain cluster of the multi-tenant, multi-cluster environment from a user to access the multi-tenant, multi-cluster environment and a determination of a user role for the user can be made by the domain cluster of the multi-tenant, multi-cluster environment based on the request. Determining the user role for the user can further comprise authenticating and authorizing the user and wherein providing the token in response to the request is performed in response to authenticating the user.

A token can be provided by the domain cluster of the multi-tenant, multi-cluster environment, in response to the request. For example, the token can comprise a Java Script Object Notation (JSON) Web Token (JWT). The token can comprise a definition of access levels for the determined user role for the user and each tenant cluster of the plurality of tenant clusters of the multi-tenant, multi-cluster environment can control access to the one or more resource objects on the one or more tenant clusters based on the definition of access levels for the determined user role for the user defined in the token.

The token can be received by one or more tenant clusters of the plurality of tenant clusters from the user and the one or more tenant clusters of the plurality of tenant clusters can perform access control on resources of the at least one tenant cluster based on the definition of access levels for the determined user role for the user defined in the token and one or more access control policies of the one or more tenant clusters of the plurality of tenant clusters. In some cases, the one or more tenant clusters of the plurality of tenant cluster comprises a single tenant cluster and the plurality of tenant clusters can enforce a hard multi-tenancy based on the definition of access levels for the determined user role for the user defined in the token. In other cases, the at least one cluster of the plurality of tenant cluster can comprise a plurality of tenant clusters enforcing a soft multi-tenancy based on the definition of access levels for the determined user role for the user defined in the token.

In some cases, the domain cluster can further perform updates of user roles, token expiry, and user management for the multi-tenant, multi-cluster environment.

According to another embodiment, a multi-tenant, multi-cluster environment can comprise a plurality of tenant clusters and a domain cluster communicatively coupled with each of the plurality of tenant clusters. The domain cluster can comprise a processor and a memory coupled with and readable by the processor and storing therein a set of instructions which, when executed by the processor, causes the processor to define a plurality of user roles. Each user role of the plurality of user roles can have a defined access permission for one or more resource objects on one or more tenant clusters of the multi-tenant, multi-cluster environment. The instructions can further cause the processor to receive a request from a user to access the multi-tenant, multi-cluster environment and determine a user role for the user based on the request. Determining the user role for the user can comprise authenticating and authorizing the user and wherein providing the token in response to the request is performed in response to authenticating the user.

The instructions can further cause the processor to provide a token in response to the request. For example, the token can comprise a JWT. The token can comprise a definition of access levels for the determined user role for the and each tenant cluster of a plurality of tenant clusters of the multi-tenant, multi-cluster environment can control access to the one or more resource objects on the one or more tenant clusters based on the definition of access levels for the determined user role for the user defined in the token.

Each tenant cluster can comprise a processor and a memory coupled with and readable by the processor and storing therein a set of instructions which, when executed by the processor, causes the processor to receive, by one or more tenant clusters of the plurality of tenant clusters, the token from the user and perform access control on resources of the at least one tenant cluster based on the definition of access levels for the determined user role for the user defined in the token and one or more access control policies of the one or more tenant clusters of the plurality of tenant clusters. For example, the one or more tenant clusters of the plurality of tenant cluster can comprise a single tenant cluster and the plurality of tenant clusters can enforce a hard multi-tenancy based on the definition of access levels for the determined user role for the user defined in the token. In another example, the at least one cluster of the plurality of tenant cluster can comprise a plurality of tenant clusters enforcing a soft multi-tenancy based on the definition of access levels for the determined user role for the user defined in the token.

The instructions stored in the memory of the domain cluster can further cause the processor of the domain cluster to perform updates of user roles, token expiry, and user management for the multi-tenant, multi-cluster environment.

According to yet another embodiment, a non-transitory, computer-readable medium can comprise a set of instructions stored therein which, when executed by one or more processors, causes the one or more processors to provide access control in a multi-tenant, multi-cluster environment by defining, by a domain cluster of the multi-tenant, multi-cluster environment, a plurality of user roles. Each user role of the plurality of user roles can have a defined access permission for one or more resource objects on one or more tenant clusters of the multi-tenant, multi-cluster environment. The domain cluster can receive a request from a user to access the multi-tenant, multi-cluster environment and can determine a user role for the user based on the request. Determining the user role for the user can comprise authenticating and authorizing the user and wherein providing the token in response to the request is performed in response to authenticating the user.

The instructions can further cause the one or more processors to provide, by the domain cluster, a token in response to the request. For example, the token can comprise a JWT. The token can comprise a definition of access levels for the determined user role for the and each tenant cluster of a plurality of tenant clusters of the multi-tenant, multi-cluster environment can control access to the one or more resource objects on the one or more tenant clusters based on the definition of access levels for the determined user role for the user defined in the token.

The instructions can further cause the one or more processors to receive, by one or more tenant clusters of the plurality of tenant clusters, the token from the user and perform, by the one or more tenant clusters of the plurality of tenant clusters, access control on resources of the at least one tenant cluster based on the definition of access levels for the determined user role for the user defined in the token and one or more access control policies of the one or more tenant clusters of the plurality of tenant clusters. In some cases, the one or more tenant clusters of the plurality of tenant cluster can comprise a single tenant cluster and the plurality of tenant clusters can enforce a hard multi-tenancy based on the definition of access levels for the determined user role for the user defined in the token. In other cases, the at least one cluster of the plurality of tenant cluster can comprise a plurality of tenant clusters enforcing a soft multi-tenancy based on the definition of access levels for the determined user role for the user defined in the token.

### BRIEF DESCRIPTION OF THE DRAWINGS

FIG. 1 is a block diagram of a cloud-based architecture according to an embodiment of the present disclosure.

FIG. 2 is a block diagram of an embodiment of the application management server according to one embodiment of the present disclosure

FIG. 3 is a block diagram of a cloud-based architecture according to one embodiment of the present disclosure.

FIG. 4 is a flowchart illustrating an exemplary process for providing access control in a multi-tenant, multi-cluster environment according to one embodiment of the present disclosure.

FIG. 5 is a flowchart illustrating additional details of an exemplary process for providing access control in a multi-tenant, multi-cluster environment according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also notable that the terms “comprising”, “including”, and “having” can be used interchangeably.

The term “automatic” and variations thereof may refer to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The term “cluster” may refer to a group of multiple worker nodes that deploy, run and manage containerized or Virtual Machine (VM)-based applications and a master node that controls and monitors the worker nodes. A cluster can have an internal and/or external network address (e.g., Domain Name System (DNS) name or Internet Protocol (IP) address) to enable communication between containers or services and/or with other internal or external network nodes.

The term “container” may refer to a form of operating system virtualization that enables multiple applications to share an operating system by isolating processes and controlling the amount of processing resources (e.g., Central Processing Unit (CPU), Graphics Processing Unit (GPU), etc.), memory, and disk those processes can access. While containers like virtual machines share common underlying hardware, containers, unlike virtual machines they share an underlying, virtualized operating system kernel and do not run separate operating system instances.

The terms “determine”, “calculate” and “compute,” and variations thereof are used interchangeably and include any type of methodology, process, mathematical operation or technique.

The term “deployment” may refer to control of the creation, state and/or running of containerized or VM-based applications. It can specify how many replicas of a pod should run on the cluster. If a pod fails, the deployment may be configured to create a new pod.

The term “domain” may refer to a set of objects that define the extent of all infrastructure under management within a single context. Infrastructure may be physical or virtual, hosted on-premises or in a public cloud. Domains may be configured to be mutually exclusive, meaning there is no overlap between the infrastructure within any two domains.

The term “domain cluster” may refer to the primary management cluster. This may be the first cluster provisioned.

The term “Knative” may refer to a platform that sits on top of containers and enables developers to build a container and run it as a software service or as a serverless function. It can enable automatic transformation of source code into a clone container or functions; that is, Knative may automatically containerize code and orchestrate containers, such as by configuration and scripting (such as generating configuration files, installing dependencies, managing logging and tracing, and writing Continuous Integration/Continuous Deployment (CI/CD) scripts. Knative can perform these tasks through build (which transforms stored source code from a prior container instance into a clone container or function), serve (which runs containers as scalable services and performs configuration and service routing), and event (which enables specific events to trigger container-based services or functions).

The term “master node” may refer to the node that controls and monitors worker nodes. The master node may run a scheduler service that automates when and where containers are deployed based on developer-set deployment requirements and available computing capacity.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” may refer to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The term “namespace” may refer to a set of signs (names) that are used to identify and refer to objects of various kinds. In Kubernetes, for example, there are three primary namespaces: default, kube-system (used for Kubernetes components), and kube-public (used for public resources). Namespaces are intended for use in environments with many users spread across multiple teams, or projects. Namespaces may not be nested inside one another, and each Kubernetes resource may be configured to only be in one namespace. Namespaces may provide a way to divide cluster resources between multiple users (via resource quota). The extension of namespaces in the present disclosure is discussed at page 9 of Exhibit “A”. At a high level, the extension to namespaces enables multiple virtual clusters (or namespaces) backed by a common set of physical (Kubernetes) cluster.

The term “pods” may refer to groups of containers that share the same compute resources and the same network.

The term “project” may refer to a set of objects within a tenant that contains applications. A project may act as an authorization target and allow administrators to set policies around sets of applications to govern resource usage, cluster access, security levels, and the like. The project construct can enable authorization (e.g., Role Based Access Control or RBAC), application management, and the like within a project. In one implementation, a project is an extension of Kubernetes' use of namespaces for isolation, resource allocation and basic authorization on a cluster basis. Project may extend the namespace concept by grouping together multiple namespaces in the same cluster or across multiple clusters. Stated differently, projects can run applications on one cluster or on multiple clusters. The resources are allocated per project basis.

The term “project administrator” or “project admin” or PA may refer to the entity or entities responsible for adding members to a project, manages users to a project, manages applications that are part of a project, specifies new policies to be enforced in a project (e.g., with respect to uptime, Service Level Agreements (SLAs), and overall health of deployed applications), etc.

The term “project member” or PM may refer to the entity or entities responsible for deploying applications on Kubernetes in a project, responsible for uptime, SLAs, and overall health of deployed applications. The PM may not have permission to add a user to a project.

The term “project viewer” or PV may refer to the interface that enables a user to view all applications, logs, events, and other objects in a project.

The term “resource”, when used with reference to Kubernetes, may refer to an endpoint in the Kubernetes Application Program Interface (API) that stores a collection of API objects of a certain kind; for example, the built-in pods resource contains a collection of pod objects.

The term “serverless computing” may refer to a way of deploying code that enables cloud native applications to bring up the code as needed; that is, it can scale it up or down as demand fluctuates and take the code down when not in use. In contrast, conventional applications deploy an ongoing instance of code that sits idle while waiting for requests.

The term “service” may refer to an abstraction, which defines a logical set of pods and a policy by which to access them (sometimes this pattern is called a micro-service).

The term “service provider” or SP may refer to the entity that manages the physical/virtual infrastructure in domains. In one implementation, a service provider manages an entire node inventory and tenant provisioning and management. Initially a service provider manages one domain.

The term “service provider persona” may refer to the entity responsible for hardware and tenant provisioning or management.

The term “tenant” may refer to an organizational construct or logical grouping used to represent an explicit set of resources (e.g., physical infrastructure (e.g., CPUs, GPUs, memory, storage, network, and cloud clusters, people, etc.) within a domain. Tenants “reside” within infrastructure managed by a service provider. By default, individual tenants do not overlap or share anything with other tenants; that is, each tenant can be data isolated, physically isolated, and runtime isolated from other tenants by defining resource scopes devoted to each tenant. Stated differently, a first tenant can have a set of resources, resource capabilities, and/or resource capacities that is different from that of a second tenant. Service providers assign worker nodes to a tenant, and the tenant admin forms the clusters from the worker nodes.

The term “tenant administrator” or “tenant admin” or TA may refer to the entity responsible for managing an infrastructure assigned to a tenant. The tenant administrator is responsible for cluster management, project provisioning, providing user access to projects, application deployment, specifying new policies to be enforced in a tenant, etc.

The term “tenant cluster” may refer to clusters of resources assigned to each tenant upon which user workloads run. The domain cluster performs lifecycle management of the tenant clusters.

The term “virtual machine” or “VM” may refer to a server abstracted from underlying computer hardware so as to enable a physical server to run multiple virtual machines or a single virtual machine that spans more than one server. Each virtual machine typically runs its own operating system instance to permit isolation of each application in its own virtual machine, reducing the chance that applications running on common underlying physical hardware will impact each other.

The term “volume” may refer to an ephemeral or persistent volume of memory of a selected size that is created from a distributed storage pool of memory. A volume may comprise a directory on disk and data or in another container and be associated with a volume driver. In some implementations, the volume is a virtual drive and multiple virtual drives can create multiple volumes. When a volume is created, a scheduler may automatically select an optimum node on which to create the volume. A “mirrored volume” refers to synchronous cluster-local data protection while a “replicated volume” refers to asynchronous cross-cluster data protection.

The term “worker node” may refer to the compute resources and network(s) that deploy, run, and manage containerized or VM-based applications. Each worker node contains the services to manage the networker between the containers, communication with the master node, and assign resources to the containers scheduled. Each worker node can include a tool that is used to manage the containers, such as Docker, and a software agent called a Kubelet that receives and executes orders from the master node (e.g., the master API server). The Kubelet is a primary node agent which executes on each worker node inside the cluster. The Kubelet receives the pod specifications through an API server and executes the container associated with the pods and ensures that the containers described in the pods are running and healthy. If Kubelet notices any issues with the pods running on the worker nodes then it tries to restart the pod on the same node and if the issue is with the worker node itself then the master node detects the node failure and decides to recreate the pods on the other healthy node.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

The present disclosure is directed to a multi-cloud platform that can provide a single plane of management console from which customers manage cloud-native applications and clusters and data using a policy-based management framework. The platform can be provided as a hosted service that is either managed centrally or deployed in customer environments. The customers could be enterprise customers or service providers. The platform can manage applications across multiple clusters, which could be residing on-premises or in the cloud or combinations thereof (e.g., hybrid cloud implementations). The platform can provide abstract core network and storage services on premises and in the cloud for stateful and stateless applications.

According to one embodiment, the platform can be adapted to provide isolation, authentication and authorization, and resource management for users in a multi-tenant, multi-cluster environment. Generally speaking, and as will be described in greater detail below, user roles can be created and RBAC permissions can be defined for the various roles to grant access on specific objects to designated user roles. These roles can be defined in a domain cluster of the multi-tenant, multi-cluster environment. Users can access the multi-tenant, multi-cluster environment through the domain cluster which, upon authenticating and authorizing the user, can issue a token to the user. For example, the token can comprise a Java Script Object Notation (JSON) Web Token (JWT) containing information about ACL policies for the user based on an assigned user role. The token can then be used at any cluster of the multi-tenant, multi-cluster environment to have access only to the objects that were provided for the user roles. The domain cluster can also update user roles, control token expiry, and manage users.

In some implementations, these services can be provided across multiple Kubernetes clusters. In other implementations, authentication and authorization services can be provided on other, non-Kubernetes clusters. It should be noted that, while this description references Kubernetes clusters by way of example, embodiments of the present disclosure are equally applicable to any type of clusters utilizing role-based access control. In case of Kubernetes clusters, the platform can leverage RBAC from Kubernetes. In case of a non-Kubernetes clusters, the platform can leverage RBAC using vault or any other RBAC implementations.

The platform can enable organizations to deliver a high-productivity Platform-as-a-Service (PaaS) that addresses multiple infrastructure-related and operations-related tasks and issues surrounding cloud-native development. It can support many container application platforms besides or in addition to Kubernetes, such as Red Hat, OpenShift, Docker, and other Kubernetes distributions, whether hosted or on-premises.

While this disclosure is discussed with reference to the Kubernetes container platform, it is to be appreciated that the concepts disclosed herein apply to other container platforms, such as Microsoft Azure™, Amazon Web Services™ (AWS), Open Container Initiative (OCI), CoreOS, and Canonical (Ubuntu) LXD™.

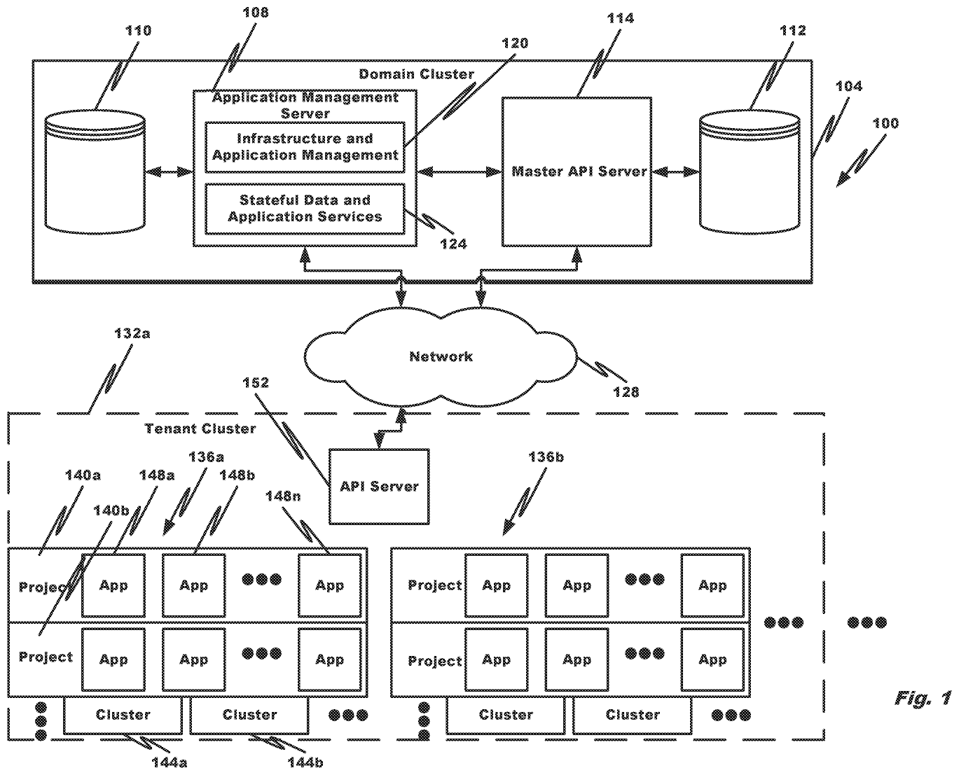

FIG. 1 is a block diagram of a cloud-based architecture according to an embodiment of the present disclosure. As illustrated in this example, a multi-cloud platform 100 can be in communication, via network 128, with one or more tenant clusters 132a, . . . . Each tenant cluster 132a, . . . can correspond to one or multiple tenants 136a, b, . . . , with each of the one or multiple tenants 136a, b, . . . in turn corresponding to a plurality of projects 140a, b, . . . and worker node clusters 144a, b, . . . . Each containerized or VM-based application 148a, b, . . . n in each project 140a, b, . . . can utilize the worker node resources in one or more of the clusters 144a, b, . . . .

To manage the tenant clusters 132a . . . the multi-cloud platform 100 can be associated with a domain cluster 104 and can comprise an application management server 108 and associated data storage 110 and master Application Programming Interface (API) server 114, which can be part of the master node (not shown) and associated data storage 112. The application management server 108 can communicate with an API server 152 assigned to the tenant clusters 132a . . . to manage the associated tenant cluster 132a . . . . In some implementations, each cluster can have a controller or control plane that is different from the application management server 108.

The servers 108 and 114 can be implemented as a physical (or bare-metal) server or cloud server. As will be appreciated, a cloud server is a physical and/or virtual infrastructure that performs application- and information-processing storage. Cloud servers are commonly created using virtualization software to divide a physical (bare metal) server into multiple virtual servers. The cloud server can use Infrastructure-as-a-Service (IaaS) model to process workloads and store information.

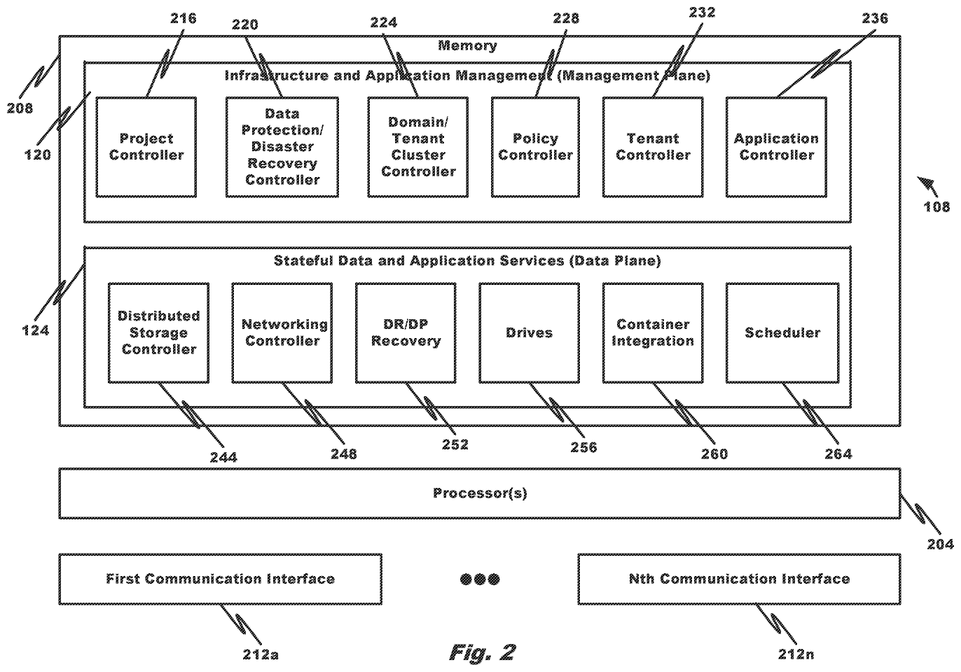

The application management server 108 can perform tenant cluster management using two management planes or levels, namely an infrastructure and application management layer 120 and stateful and application services layer 124. The stateful and application services layer 124 can abstract network and storage resources to provide global control and persistence, span on-premises and cloud resources, and provide intelligent placement of workloads based on logical data locality and block storage capacity. These layers are discussed in detail in connection with FIG. 2.

The API servers 114 and 152, which effectively act as gateways to the clusters, can be commonly each implemented as a Kubernetes API server that implements a RESTful API over HTTP, performs all API operations, and is responsible for storing API objects into a persistent storage backend. Because all of the API server's persistent state is stored in external storage (which is one or both of the databases 110 and 112 in the case of master API server 114) that are typically external to the API server, the server itself is typically stateless and can be replicated to handle request load and provide fault tolerance. The API servers commonly provide API management (the process by which APIs are exposed and managed by the server), request processing (the target set of functionality that processes individual API requests from a client), and provide internal control loops (that provide internals responsible for background operations necessary to the successful operation of the API server).

In one implementation, the API server receives https requests from Kubectl or any automation to send requests to any Kubernetes cluster. Users can access the cluster using API server 152 and it can store the API objects into an etcd data structure. As will be appreciated, etcd is a consistent and highly-available key value store used as Kubernetes' backing store for all cluster data. The master API server 114 can receive https requests from user interface (UI) or dmctl. This provides a single endpoint of contact for all UI functionality. It typically validates the request and sends the request to the API server 152. An agent controller (not shown) can reside on each tenant cluster and perform actions in each cluster. Domain cluster components can use Kubernetes native or CustomResourceDefinitions (CRD) objects to communicate with the API server 152 in the tenant cluster. The agent controller can handle the CRD objects.

In one implementation, the tenant clusters can run controllers such as an HNC controller, storage agent controller, or agent controller. The communication between domain cluster components and tenant cluster can be via the API server 152 on the tenant clusters. The applications on the domain cluster 104 can communicate with applications 148 on tenant clusters 144 and the applications 148 on one tenant cluster 144 can communicate with applications 148 on another tenant cluster 144 to implement specific functionality.

Data storage 110 is normally configured as a database and stores data structures necessary to implement the functions of the application management server 108. For example, data storage 110 comprises objects and associated definitions corresponding to each tenant cluster 144, and project and references to the associated cluster definitions in data storage 112. Other objects/definitions include networks and endpoints (for data networks), volumes (created from a distributed data storage pool on demand), mirrored volumes (created to have mirrored copies on one or more other nodes), snapshot volumes (a point-in-time image of a corresponding set of volume data), linked clones (volumes created from snapshot volumes are called linked clones of the parent volume and share data blocks with the corresponding snapshot volume until the linked clone blocks are modified), namespaces, access permissions and credentials, and other service-related objects.

Namespaces enable the use of multiple virtual clusters backed by a common physical cluster. The virtual clusters can be defined by namespaces. Names of resources are unique within a namespace but not across namespaces. In this manner, namespaces allow division of cluster resources between multiple uses. Namespaces are also used to manage access to application and service-related Kubernetes objects, such as pods, services, replication, controllers, deployments, and other objects that are created in namespaces.

Data storage 112 can include the data structures enabling cluster management by the master API server 114. In one implementation, data storage 112 can be configured as a distributed key-value lightweight database, such as an etcd key value store. In Kubernetes, it is a central database for storing the current cluster state at any point in time and also used to store the configuration details such as subnets, configuration maps, etc.

The communication network 128, in some embodiments, can be any trusted or untrusted computer network, such as a WAN or LAN. The Internet is an example of the communication network 128 that constitutes an IP network consisting of many computers, computing networks, and other communication devices located all over the world. Other examples of the communication network 128 include, without limitation, an Integrated Services Digital Network (ISDN), the Public Switched Telephone Network (PSTN), a cellular network, and any other type of packet-switched or circuit-switched network known in the art. In some embodiments, the communication network 128 may be administered by a Mobile Network Operator (MNO). It should be appreciated that the communication network 128 need not be limited to any one network type, and instead may be comprised of a number of different networks and/or network types. Moreover, the communication network 128 may comprise a number of different communication media such as coaxial cable, copper cable/wire, fiber-optic cable, antennas for transmitting/receiving wireless messages, wireless access points, routers, and combinations thereof.

With reference now to FIG. 2, additional details of the application management server 108 will be described in accordance with embodiments of the present disclosure. The server 108 is shown to include processor(s) 204, memory 208, and communication interfaces 212a . . . n. These resources may enable functionality of the server 108 as will be described herein.

The processor(s) 204 can correspond to one or many computer processing devices. For instance, the processor(s) 204 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor(s) 204 may be provided as a microcontroller, microprocessor, Central Processing Unit (CPU), or plurality of microprocessors that are configured to execute the instructions sets stored in memory 208. Upon executing the instruction sets stored in memory 208, the processor(s) 204 enable various centralized management functions over the tenant clusters.

The memory 208 may include any type of computer memory device or collection of computer memory devices. The memory 208 may include volatile and/or non-volatile memory devices. Non-limiting examples of memory 208 include Random-Access Memory (RAM), Read-Only Memory (ROM), flash memory, Electronically-Erasable Programmable ROM (EEPROM), Dynamic RAM (DRAM), etc. The memory 208 may be configured to store the instruction sets depicted in addition to temporarily storing data for the processor(s) 204 to execute various types of routines or functions.

The communication interfaces 212a . . . n may provide the server 108 with the ability to send and receive communication packets (e.g., requests) or the like over the network 128. The communication interfaces 212a . . . n may be provided as a Network Interface Card (MC), a network port, drivers for the same, and the like. Communications between the components of the server 108 and other devices connected to the network 128 may all flow through the communication interfaces 212a . . . n. In some embodiments, the communication interfaces 212a . . . n may be provided in a single physical component or set of components, but may correspond to different communication channels (e.g., software-defined channels, frequency-defined channels, amplitude-defined channels, etc.) that are used to send/receive different communications to the master API server 112 or API server 152.

The illustrative instruction sets that may be stored in memory 208 include, without limitation, in the infrastructure and application management (management plane) 124, the project controller 216, data protection/disaster recovery controller 220, domain/tenant cluster controller 224, policy controller 228, tenant controller 232, and application controller 236 and, in the stateful data and application services (data plane) 124, distributed storage controller 244, networker controller 248, Data Protection (DP)/Disaster Recovery (DR) 252, logical and physical drives 256, container integration 260, and scheduler 264. Functions of the application management server 108 enabled by these various instruction sets are described below. Although not depicted, the memory 208 may include instructions that enable the processor(s) 204 to store data into and retrieve data from data storage 110 and 112.

It should be appreciated that the instruction sets depicted in FIG. 2 may be combined (partially or completely) with other instruction sets or may be further separated into additional and different instruction sets, depending upon configuration preferences for the server 108. Said another way, the particular instruction sets depicted in FIG. 2 should not be construed as limiting embodiments described herein.

In some embodiments, the instructions for the project controller 216, when executed by processor(s), may enable the server 108 to control, on a project-by-project basis, the resource utilization based on project members and control things such as authorization of resources within a project or across other projects using a network access control list (ACL) policies. The project causes grouping of resources such as memory, CPU, storage and network and quota of these resources. The project members view or consume resources based on authorization policies. The projects could be on only one cluster or span across multiple or different clusters.

In some embodiments, instructions for the application mobility and disaster recovery controller 220 (at the management plane) and the data protection disaster recovery/DP 252 (at the data plane), when executed by processor(s), may enable the server 108 to implement containerized or VM-based application migration from one cluster to another cluster using migration agent controllers on individual clusters.

In some embodiments, the instructions for the domain/tenant cluster controller 224, when executed by processor(s), may enable the server 108 to control provisioning of cloud-specific clusters and manage their native Kubernetes clusters. Other cluster operations that can be controlled include adopting an existing cluster, removing the cluster from the server 108, upgrading a cluster, creating the cluster, and destroying the cluster.

In some embodiments, instructions for the policy controller 228, when executed by the processor(s), may enable the server 108 to effect policy-based management, whose goal is to capture user intent via templates and enforce them declaratively for different applications, nodes, and clusters. An application may specify a policy for an application or storage. The policy controller 228 can manage policy definitions and propagate them to individual clusters. The policy controller 228 can interpret the policies and give the policy enforcement configuration to corresponding feature specific controllers. The policy controller 228 could be run at the tenant cluster or at the master node based on functionality.

According to one embodiment, the policy controller 228 can define a plurality of user roles. Each user role of the plurality of user roles can have a defined access permission for one or more resource objects on one or more tenant clusters of the multi-tenant, multi-cluster environment as may be provided by multi-cloud platform 100. In response to receiving a request from a user to access the multi-tenant, multi-cluster environment the policy controller 228 can determine a user role for the user based on the request. Determining the user role for the user can comprise authenticating and authorizing the user and providing the token in response to the request can be performed in response to authenticating the user. In some implementations, user management and authentication and authorization may be performed by a third-party service provider such as HashiCorp Vault, for example.

Once the user is authenticated and authorized, the policy controller 228 can provide a token in response to the request. For example, the token can comprise a JWT. The token can comprise a definition of access levels for the determined user role for the and each tenant cluster of a plurality of tenant clusters of the multi-tenant, multi-cluster environment can control access to the one or more resource objects on the one or more tenant clusters based on the definition of access levels for the determined user role for the user defined in the token. This can be done via formatting the membership of a user to a tenancy and access level to a project within that tenancy using a hierarchical pattern such as /platform/<tenant-name>/project/<project-name>/<role-name>. The JWT token can have a list of such strings associated with an user entity. Each of these strings can have a one-to-one correspondence with groups defined in any particular Kubernetes cluster. An authentication webhook can perform the duties of intercepting incoming user JWT token and populating Kubernetes roles using this scheme.

According to one embodiment, the multi-cloud platform 100 can provide authentication on top of authentication unaware services by checking for authentication in the validating webhooks prior to giving the requests to underlying services. More specifically, the multi-cloud platform 100 can further comprise several micro-services and some of these micro-services may not be natively aware of authentication. In order to provide authentication-based access control on such services, multi-cloud platform 100 can provide a middleware that intercepts HTTP requests going to such services and based on the URI path of the request, a determination can be made of the virtual representation of the destination service by its equivalent path in an authentication agent such as Vault, for example. A read operation can then be performed on the virtual representation of the service in authentication agent and based on successful authorization, the HTTP request can be forwarded downstream. For instance, a particular user entity may only have access to project A but not project B. While data for both projects can be stored in service C, the user should be denied access to data for project B. So, the incoming JWT ID token of the user can be used to perform a read operation on an internal representation of the service at /platform/<tenant-name>/service/<service-name>/project/<project-name>. If the read operation succeeds, the HTTP request can be forwarded downstream.

Other examples of policy control include application policy management (e.g., containerized or VM-based application placement, failover, migration, and dynamic resource management), storage policy management (e.g., storage policy management controls the snapshot policy, backup policy, replication policy, encryption policy, etc. for an application), network policy management, security policies, performance policies, access control lists, and policy updates.

In some embodiments, instructions for the application controller 236, when executed by the processor(s), may enable the server 108 to deploy applications, effect application failover/fallback, application cloning, cluster cloning, and monitoring applications. In one implementation, the application controller enables users to launch their applications from the server 108 on individual clusters or a set of clusters using a Kubectl command.

In some embodiments, the instructions for the networker controller 248, when executed by processor(s), may enable the server 108 to enable multi-cluster or container networker (particularly at the data link and network layers) in which services or applications run mostly on one cluster and, for high availability reasons, use another cluster either on premises or on the public cloud. The service or application can migrate to other clusters upon user request or for other reasons. In most implementations, services run in one cluster at a time. The network controller 248 can also enable services to use different clusters simultaneously and enable communication across the clusters. The networker controller 248 can attach one or more interfaces (programmed to have a specific performance configuration) to a selected container while maintaining isolation between management and data networks. This can be done by each container having the ability to request one or more interfaces on specified data networks.

In some embodiments, the instructions for the logical drives 408a-n when executed by processor(s), may enable the server 108 to provide a common API (via the Container Networker Interface) for connecting containers to an external network and expose (via the Container Storage Interface (CSI)) arbitrary block and file storage systems to containerized or VM-based workloads. In some implementations, CSI can expose arbitrary block and file storage systems to containerized workloads on Container Orchestration Systems (COs), such as Kubernetes and AWS.

In some embodiments, the instructions for the container integration 260, when executed by processor(s), may enable the server 108 to provide (via OpenShift) a cloud-based container platform that is both containerization software and a platform-as-a-service (PaaS).

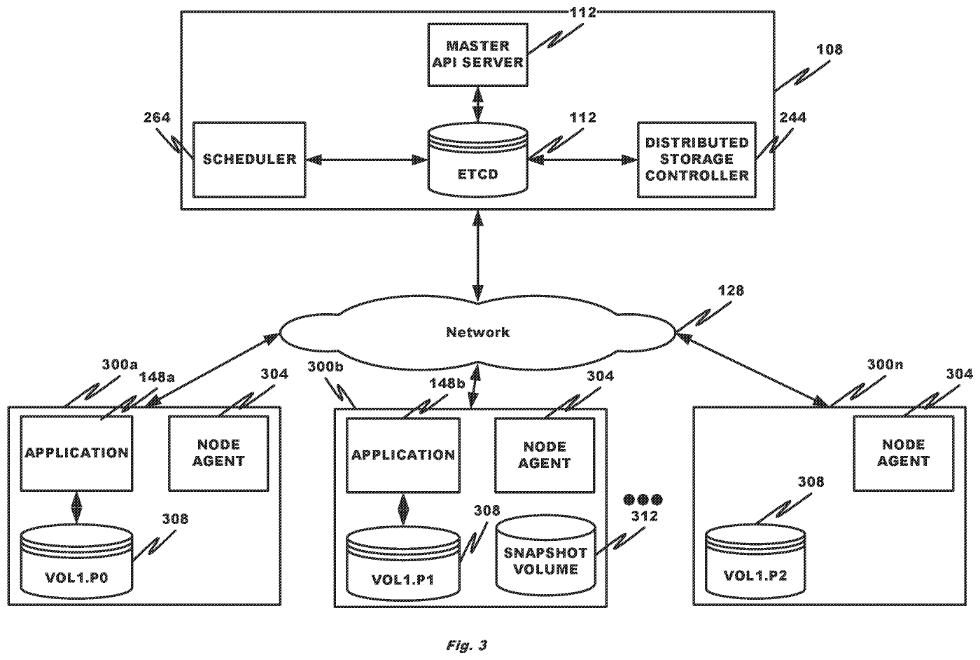

FIG. 3 illustrates the operations of the scheduler 264 and distributed storage controller 244 in more detail. The application server 108 is in communication, via network 128, with a plurality of worker nodes 300a-n. While FIG. 3 depicts the master API server separate from the worker nodes, in some implementations the same node can act as both a master and worker node.

The database 112 is depicted as an “/etc distributed” or etcd key value store that stores physical data as key-value pairs in a persistent b+tree. Each revision of the etcd key value store's state typically contains only the delta from a previous revision for storage efficiency. A single revision may correspond to multiple keys in the tree. The key of a key-value pair is a 3-tuple (major, sub, type). The database 112, in this implementation, stores the entire state of a cluster: that is, it stores the cluster's configuration, specifications, and the statuses of the running workloads. In Kubernetes in particular, etcd's “watch” function monitor the data and reconfigures itself when changes occur.

The worker nodes 300a-n can be part of a common cluster or different clusters 144, the same or different projects 140, and/or the same or different tenant clusters 132, depending on the implementation. The worker nodes 300 comprise the compute resources, drives on which volumes are created for applications, and network(s) that deploy, run, and manage containerized or VM-based applications. For example, a first worker node 300a comprises an application 148a, a node agent 304, and a database 308 containing storage resources. The node agent 304, or Kubelet in Kubernetes, runs on each worker node and ensures that all containers are running and healthy in a pod and makes any configuration changes on the worker nodes. The database 308 or other data storage resource corresponds to the pod associated with the worker node (e.g., the database 308 for first worker node 300a is identified as “P0” for pod 0, the database 308 for the second worker node 300b is identified as “P1” for pod 1, and the database 308 for the nth worker node 300n is identified as “P2” for pod 2. Each database 308 in the first and second worker nodes 300a and b is shown to include a volume associated with respective application 148a and b. The volume in the nth worker node 300n, depending on the implementation, could be associated with either of the applications 148a orb. As will be appreciated, an application's volume can be divided among the storage resources of multiple worker nodes and is not limited to the storage resources of the worker node running the application.

The master API server 112, in response to user requests to instantiate an application or create an application or snapshot 312 volume, records the request in the etcd database 112, and, in response, the scheduler 264 determines on which database (s) 308 the volume should be created in accordance with placement polices specified by the policy controller 228. For example, the placement policy can select the worker node having the least amount of storage resources consumed at that point, that is required for optimal operation of the selected application 148, or that is selected by the user.

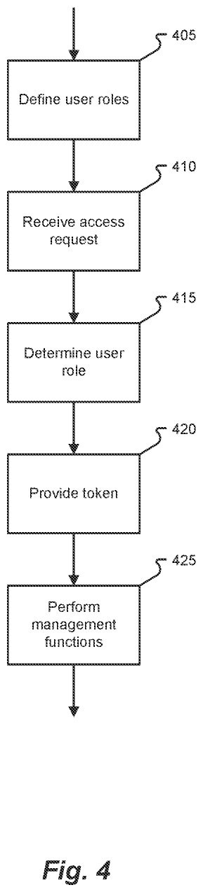

FIG. 4 is a flowchart illustrating an exemplary process for providing access control in a multi-tenant, multi-cluster environment according to one embodiment of the present disclosure. As illustrated in this example, providing access control in a multi-tenant, multi-cluster environment as may be provided by multi-cloud environment 100 can comprise defining 405, by a domain cluster 104 of the multi-tenant, multi-cluster environment, a plurality of user roles. Each user role of the plurality of user roles can have a defined access permission for one or more resource objects on one or more tenant clusters 132a of the multi-tenant, multi-cluster environment.

The user roles can include, but are not limited to a service provider role, a tenant administrator role, a project administrator role, a project member role, and/or a project viewer role. Each of these roles can map to various tasks required to take care of individual objects. For example, a service provider role can be defined for a user or users who manage(s) the physical/virtual infrastructure in domains. In one implementation, a service provider can be provided access permission to manage an entire node inventory and tenant provisioning and management. A tenant administrator role can be defined for a user or users responsible for managing an infrastructure assigned to a tenant. The tenant administrator can be responsible for and granted access permission to perform cluster management, project provisioning, providing user access to projects, application deployment, specifying new policies to be enforced in a tenant, etc. A project administrator role can be defined for a user or users responsible for adding members to a project, manages users to a project, manages applications that are part of a project, specifies new policies to be enforced in a project (e.g., with respect to uptime, Service Level Agreements (SLAs), and overall health of deployed applications), etc. A project member role can be defined for a user or users responsible for deploying applications on Kubernetes in a project, responsible for uptime, SLAs, and overall health of deployed applications. A project viewer role can be defined for a user or users granted access permission to view applications, logs, events, and other objects in a project.

Once various roles are defined 405, a request can be received by the domain cluster 104 of the multi-tenant, multi-cluster environment from a user to access the multi-tenant, multi-cluster environment. A determination 415 of a user role for the user can be made by the domain cluster 104 of the multi-tenant, multi-cluster environment based on the request. Determining 415 the user role for the user can comprise, for example, authenticating and authorizing the user. According to one embodiment, authentication and authorization may be performed by a third-party service provider accessible by the domain cluster 104.

In response to authenticating and authorizing the user and determining 415 a user role for the user, a token can be provided 420 by the domain cluster 104 of the multi-tenant, multi-cluster environment to the requesting user. For example, the token can comprise a Java Script Object Notation (JSON) Web Token (JWT) defining access levels for the determined user role for the user. The user can the use this token to access resources on one or more tenant clusters 132a and each tenant cluster of the plurality of tenant clusters of the multi-tenant, multi-cluster environment can control access to the one or more resource objects on the one or more tenant clusters based on the definition of access levels for the determined user role for the user defined in the token.

That is, the designated user roles and object information for which permission is granted can be specified in the JWT token and the same token can be used at any cluster to have access only to the objects that were provided for the user role. This can be done via formatting the membership of a user to a tenancy and access level to a project within that tenancy using a hierarchical pattern such as /platform/<tenant-name>/project/<project-name>/<role-name>. The JWT token can have a list of such strings associated with an user entity. Each of these strings can have a one-to-one correspondence with groups defined in any particular Kubernetes cluster. An authentication webhook of each tenant cluster 132a can perform the duties of intercepting incoming user JWT tokens and populating Kubernetes roles using this scheme.

In some cases, and at any given time, the domain cluster 104 can further perform 435 one or more management functions for the multi-tenant, multi-cluster environment. For example, these one or more management functions can include, but are not limited to, updates of user roles, token expiry, etc.

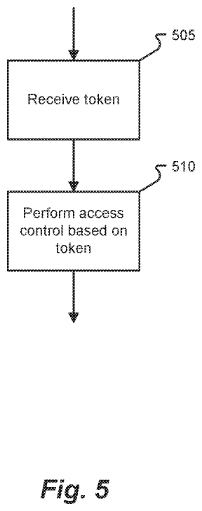

FIG. 5 is a flowchart illustrating additional details of an exemplary process for providing access control in a multi-tenant, multi-cluster environment according to one embodiment of the present disclosure. As illustrated in this example, the token can be received 505 from the user by one or more tenant clusters 132a of the plurality of tenant clusters. As noted above, an authentication webhook of each tenant cluster 132a can perform the duties of intercepting incoming user JWT tokens when the user attempts to access a resource of that tenant cluster.

The one or more tenant clusters 132a of the plurality of tenant clusters can perform 510 access control on resources of the at least one tenant cluster based on the definition of access levels for the determined user role for the user defined in the token and/or one or more access control policies of the one or more tenant clusters of the plurality of tenant clusters. The one or more tenant clusters of the plurality of tenant cluster can comprise a single tenant cluster, i.e., a cluster hosting a single tenant or a multi-tenant cluster, i.e., hosting multiple tenants on the same cluster or clusters. In either case, the plurality of tenant clusters together can enforce a hard multi-tenancy or a soft tenancy based on the definition of access levels for the determined user role for the user defined in the token. In a hard tenancy, none of the tenants will be aware of any of the other tenants and, of course, will not be given any access to resources of those tenants. In a soft tenancy, a tenant may be aware of one or more other tenants and may, in some cases, even be given some level of access to some resources of the other tenant. Soft tenancy may be implemented, for example, between divisions or branches of the same corporation or other entity.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for providing access control in a multi-tenant, multi-cluster environment, the method comprising:
defining, by a domain cluster of the multi-tenant, multi-cluster environment, a plurality of user roles, each user role of the plurality of user roles having a defined access permission for one or more resource objects on one or more tenant clusters of the multi-tenant, multi-cluster environment;
receiving, by the domain cluster of the multi-tenant, multi-cluster environment, a request from a user to access the multi-tenant, multi-cluster environment;
determining, by the domain cluster of the multi-tenant, multi-cluster environment, a user role for the user based on the request; and
providing, by the domain cluster of the multi-tenant, multi-cluster environment, a token in response to the request, the token comprising a definition of access levels for the determined user role for the and wherein each tenant cluster of a plurality of tenant clusters of the multi-tenant, multi-cluster environment controls access to the one or more resource objects on the one or more tenant clusters based on the definition of access levels for the determined user role for the user defined in the token.

2. The method of claim 1, wherein the token comprises a Java Script Object Notation (JSON) Web Token (JWT).

3. The method of claim 1, wherein determining the user role for the user further comprises authenticating and authorizing the user and wherein providing the token in response to the request is performed in response to authenticating the user.

4. The method of claim 1, further comprising:
receiving, by one or more tenant clusters of the plurality of tenant clusters, the token from the user; and
performing, by the one or more tenant clusters of the plurality of tenant clusters, access control on resources of the at least one tenant cluster based on the definition of access levels for the determined user role for the user defined in the token and one or more access control policies of the one or more tenant clusters of the plurality of tenant clusters.

5. The method of claim 4, wherein the one or more tenant clusters of the plurality of tenant cluster comprises a single tenant cluster and the plurality of tenant clusters enforce a hard multi-tenancy based on the definition of access levels for the determined user role for the user defined in the token.

6. The method of claim 4, wherein the at least one cluster of the plurality of tenant cluster comprises a plurality of tenant clusters enforcing a soft multi-tenancy based on the definition of access levels for the determined user role for the user defined in the token.

7. The method of claim 1, wherein the domain cluster further performs updates of user roles, token expiry, and user management for the multi-tenant, multi-cluster environment.

8. A multi-tenant, multi-cluster environment comprising:
a plurality of tenant clusters; and
a domain cluster communicatively coupled with each of the plurality of tenant clusters, the domain cluster comprising a processor and a memory coupled with and readable by the processor and storing therein a set of instructions which, when executed by the processor, causes the processor to:
define a plurality of user roles, each user role of the plurality of user roles having a defined access permission for one or more resource objects on one or more tenant clusters of the multi-tenant, multi-cluster environment,
receive a request from a user to access the multi-tenant, multi-cluster environment,
determine a user role for the user based on the request, and
provide a token in response to the request, the token comprising a definition of access levels for the determined user role for the and wherein each tenant cluster of a plurality of tenant clusters of the multi-tenant, multi-cluster environment controls access to the one or more resource objects on the one or more tenant clusters based on the definition of access levels for the determined user role for the user defined in the token.

9. The multi-tenant, multi-cluster environment of claim 8, wherein the token comprises a Java Script Object Notation (JSON) Web Token (JWT).

10. The multi-tenant, multi-cluster environment of claim 8, wherein determining the user role for the user further comprises authenticating and authorizing the user and wherein providing the token in response to the request is performed in response to authenticating the user.

11. The multi-tenant, multi-cluster environment of claim 8, wherein each tenant cluster comprises:
a processor; and
a memory coupled with and readable by the processor and sotring therein a set of instructions which, when executed by the processor, causes the processor to:
receive, by one or more tenant clusters of the plurality of tenant clusters, the token from the user, and
perform, by the one or more tenant clusters of the plurality of tenant clusters, access control on resources of the at least one tenant cluster based on the definition of access levels for the determined user role for the user defined in the token and one or more access control policies of the one or more tenant clusters of the plurality of tenant clusters.

12. The multi-tenant, multi-cluster environment of claim 11, wherein the one or more tenant clusters of the plurality of tenant cluster comprises a single tenant cluster and the plurality of tenant clusters enforce a hard multi-tenancy based on the definition of access levels for the determined user role for the user defined in the token.

13. The multi-tenant, multi-cluster environment of claim 11, wherein the at least one cluster of the plurality of tenant cluster comprises a plurality of tenant clusters enforcing a soft multi-tenancy based on the definition of access levels for the determined user role for the user defined in the token.

14. The multi-tenant, multi-cluster environment of claim 8, wherein the domain cluster further performs updates of user roles, token expiry, and user management for the multi-tenant, multi-cluster environment.

15. A non-transitory, computer-readable medium comprising a set of instructions stored therein which, when executed by one or more processors, causes the one or more processors to provide access control in a multi-tenant, multi-cluster environment by:
defining, by a domain cluster of the multi-tenant, multi-cluster environment, a plurality of user roles, each user role of the plurality of user roles having a defined access permission for one or more resource objects on one or more tenant clusters of the multi-tenant, multi-cluster environment;
receiving, by the domain cluster, a request from a user to access the multi-tenant, multi-cluster environment;
determining, by the domain cluster, a user role for the user based on the request; and
providing, by the domain cluster, a token in response to the request, the token comprising a definition of access levels for the determined user role for the and wherein each tenant cluster of a plurality of tenant clusters of the multi-tenant, multi-cluster environment controls access to the one or more resource objects on the one or more tenant clusters based on the definition of access levels for the determined user role for the user defined in the token.

16. The non-transitory, computer-readable medium of claim 15, wherein the token comprises a Java Script Object Notation (JSON) Web Token (JWT).

17. The non-transitory, computer-readable medium of claim 15, wherein determining the user role for the user further comprises authenticating and authorizing the user and wherein providing the token in response to the request is performed in response to authenticating the user.

18. The non-transitory, computer-readable medium of claim 15, wherein the instructions further cause the one or more processors to:
receive, by one or more tenant clusters of the plurality of tenant clusters, the token from the user; and
perform, by the one or more tenant clusters of the plurality of tenant clusters, access control on resources of the at least one tenant cluster based on the definition of access levels for the determined user role for the user defined in the token and one or more access control policies of the one or more tenant clusters of the plurality of tenant clusters.

19. The non-transitory, computer-readable medium of claim 18, wherein the one or more tenant clusters of the plurality of tenant cluster comprises a single tenant cluster and the plurality of tenant clusters enforce a hard multi-tenancy based on the definition of access levels for the determined user role for the user defined in the token.

20. The non-transitory, computer-readable medium of claim 18, wherein the at least one cluster of the plurality of tenant cluster comprises a plurality of tenant clusters enforcing a soft multi-tenancy based on the definition of access levels for the determined user role for the user defined in the token.
